(19) United States
(12) Patent Application Publication
(10) Pub. No.: US 2013/0306187 A1
(43) Pub. Date: Nov. 21, 2013

(54) CONVEYING PIPE PART OF A PNEUMATIC MATERIAL CONVEYING SYSTEM AND A METHOD FOR FORMING A PIPE JOINT

(71) Applicant: Göran Sundholm, Tuusula (FI)

(72) Inventor: Göran Sundholm, Tuusula (FI)

(73) Assignee: MARICAP OY, Vantaa (FI)

(21) Appl. No.: 13/980,957

(22) PCT Filed: Jan. 20, 2012
(86) PCT No.: PCT/FI12/50050

§ 371 Date: Jul. 22, 2013

(30) Foreign Application Priority Data
Jan. 24, 2011 (FI) 20115062
Jul. 6, 2011 (FI) 20115727
Oct. 24, 2011 (FI) 20116046

(51) Int. Cl. F16L 9/147

(52) U.S. Cl. CPC F16L 9/147
USPC 138/153; 156/304.2; 156/196; 156/221

(57) ABSTRACT

A conveying pipe part (2) of a pneumatic material conveying system, more particularly of a conveying system for wastes, which conveying pipe part comprises a wall, which is formed from at least two layers, at least the first one of which is a plastic material layer (12) and extends to the outer surface of the pipe part (2). The plastic material layer (12) is of plastic material or of plastic composite material, and in that the wall of the pipe part (2) comprises a second layer, a reinforcement part (8), which reinforcement part is preferably tubular part, and arranged in the wall of the pipe part (2) at a distance inwards from the outer surface.

### BACKGROUND OF THE INVENTION

The object of the invention is a conveying pipe part, as defined in the preamble of claim 1, of a pneumatic material conveying system, more particularly of a conveying system for wastes, which conveying pipe part comprises a wall, which is formed from at least two layers, at least the first one of which is a plastic material layer and extends to the outer surface of the pipe part.

The object of the invention is also a method as defined in claim 20 for forming a pipe joint of the conveying piping of a pneumatic material conveying system, more particularly of a conveying system for wastes.

In connection with pneumatic material conveying systems metal pipes are often used in the conveying piping. Particularly in large systems, in which the conveying distances of the material are long, the conveying pipings, more particularly the trunk pipings, can, in terms of their length, be formed into quite long, typically a number of kilometers long, conveying pipings. The pipe diameters of the conveying pipings of prior-art systems are quite large, in the region of 200-800 mm, in which case the costs of piping formed from metal pipes are rather high.

Efforts have been made to reduce these costs by forming material conveying pipings from plastic or from plastic composite material. Material that sets requirements for the wear-resistance of pipe parts is often conveyed in pneumatic material conveying systems. More particularly in pneumatic systems intended for conveying waste, materials that set their own requirements for the wear-resistance of the conveying piping are often transported. Such materials are e.g. glass, metal, sand and corresponding materials. The parts of a pipe that are susceptible to wear are e.g. pipe elbows or separate points of connection. It has also been observed that the wearing of plastic material on the inside surface of a pipe increases when the temperature of the pipe increases e.g. from friction, such as when the material to be conveyed hits the inside surface of the pipe, or owing to external conditions.

In addition, there is often a need to achieve different radii of curvature in a conveying pipe. In pipe parts manufactured from plastic material or from plastic composite material, heat treatment of the pipe part is required so that the pipe part remains in the bent shape. Heat treatment possibilities are very limited or even impossible, especially in installation conditions. When bending a pipe there is also the danger that the pipe bends such that the size or shape of the flow aperture of the pipe changes in an undesirable way, which especially in pneumatic conveying pipings intended for waste transport can adversely affect the operability of the system.

In conveying pipings, particularly those formed from plastic pipes or from plastic composite pipes, bushing joints can be used generally for joining different pipe parts end-to-end to each other. The point of connection is placed into the bushing, i.e. into the sleeve part, such that the ends of the pipe parts to be connected together are inside the bushing and the bushing is thus around the point of connection extending in the longitudinal direction of the pipes some distance from the point of connection in both directions. The bushing part or the section to be connected of the pipe part is provided with thermal resistors or corresponding, in which case when forming the joint electric current is conducted to the resistors, in which case the resistors heat up and a joint is formed between the sleeve part and the pipe parts. Thermoplastic pipe joints of the type described above are described e.g. in the publications U.S. Pat. No. 2,739,829, U.S. Pat. No. 4,530,521 and U.S. Pat. No. 4,906,313.

Also other plastic welding methods, according to the target of application, can be used for joining pipes. Typical weldable plastics are e.g. polyethylene (PE) and polypropylene (PP). When welding plastic the pieces (and the possible filling agent) are first heated to a certain welding temperature specific to the plastic type.

Welding occurs when the material cools under the influence of a welding pressure. For example, in butt welding two plastic pipe parts are welded together by first heating the cleaned ends of a pipe against a hot plate and by pressing them immediately together. The welding pressure is usually maintained hydraulically. The pipes to be butt-welded can also be quite thick (e.g. 800 mm), in which case the pressures and compression times to be used for the welding are correspondingly long. In hot-air welding the plastic pieces are fixed together by heating them with hot air and by supplying filler wire to the heated spot. Hot-air welding is used e.g. in the repair work and connection work of the outer shells (typically of polyethylene) of district-heating pipes. In extruder welding the plastic pieces are fixed together as in hot-air welding, but instead of welding wire the filling agent is the filler mass formed by the extruder device. Extruders usually make the filler mass from welding wire, sometimes also from plastic granules. With an extruder a thicker welded seam is achieved than with hot-air welding.

The purpose of this invention is to achieve a completely new type of solution for a pipe joint, by means of which the problems of prior-art solutions can be avoided.

One important aim is to achieve a pipe joint solution applicable to the conveying pipings of pneumatic waste transporting systems. Yet another aim is to achieve a solution for conveying piping, which is formed mainly from plastic material or from plastic composite material, by means of which solution the drawbacks of the state of the art are avoided. One aim is to achieve a pipe part, which can be bent, even in installation conditions, into the desired shape and the joining of which can be performed easily also in a plastic composite pipe or a plastic pipe. Another aim is to achieve a pipe part, which is suited for use in terms of its wear-resistance properties in the conveying pipings of pneumatic conveying systems for waste material.

Yet another aim is to achieve a solution for joining the pipe parts of conveying piping, in which joining the most typical joint welding method or gluing of plastics, more particularly of plastic pipes, can be used.

### BRIEF DESCRIPTION OF THE INVENTION

The invention is based on a concept in which the pipe part comprises a combination containing a metallic reinforcement part, such as a steel pipe, on top of which a tubular plastic composite layer or a plastic layer is arranged. The pipe part is connected to a second pipe part by joining the plastic parts or plastic composite parts to each other directly or via a sleeve part with a plastic welding method or by gluing.

The conveying pipe part according to the invention is characterized by what is stated in claim 1.

The pipe part according to the invention is also characterized by what is stated in claims 2-19. The method according to the invention is characterized by what is stated in claim 20.

The method according to the invention is also characterized by what is stated in claims 21-26.

The solution according to the invention has a number of important advantages. By forming the pipe part to comprise a combination containing a metallic reinforcement part, such as a steel pipe, on top of which a tubular plastic composite layer or a plastic layer is arranged, or which reinforcement part is arranged inside a plastic composite layer or a plastic layer, a pipe part with good shape retention and bendability is achieved. The joining of a pipe part according to the invention end-to-end to each other or to a plastic composite pipe or to a plastic pipe is extremely simple and fast, and the joint can further be performed by forming a joint just between the plastic composite layer or the plastic layer of the different pipe parts. The steel pipes that are reinforcement are not welded end-to-end to each other because the plastic joint surface is so thick, in which case the joint is formed to be of sufficient strength. The joint can be formed by using a bushing, i.e. a sleeve part, which is disposed on the point of connection between the pipe parts such that the ends of the pipe parts to be joined together are inside the bushing and the bushing is thus around the point of connection extending in the longitudinal direction of the pipes some distance from the point of connection in both directions. The bushing part is provided with thermal resistors or corresponding, in which case when forming the joint electric current is conducted to the resistors, in which case the resistors heat up and a joint is formed between the bushing part and the plastic or plastic composite material of the pipe parts. The joint can also be formed by welding the different pipe parts to each other with a plastic weld at the surface layer, said surface layer being of plastic or of plastic composite. By using a tubular part as the reinforcement part, which tubular part forms the inside surface of the pipe part, the wear-resistance of the pipe part can possibly be improved. The pipe part can be formed e.g. by baking a plastic pipe or a plastic composite pipe around the outer surface of a tubular reinforcement part, such as of a steel pipe. A metallic reinforcement part, such as a tubular part, which forms the inside surface of the pipe part, equalizes the temperature in pipe elbows by conducting heat away from points at which wear occurs. On the other hand, the material of a metallic reinforcement part is selected such that it is wear-resistant and has a relatively low coefficient of friction, in which case it in turn has a reducing effect on the rise in temperature caused by friction. A pipe part comprising a reinforcement part according to the invention does not buckle when bending as easily as a plastic pipe or a plastic composite pipe. The reinforcement part prevents undesired shape deformation, e.g. after bending. By arranging reliefs or cuts in the reinforcement part of a pipe part, the bending of the pipe part can be facilitated. In this case the bending is easy and when bending the set radius is created when the walls of the cut contact each other. Bending can in this case be performed without expensive bending machines. Pipe parts can be transported directly to the worksite and can be bent there easily without a bending machine. When bending, the reliefs or cuts in the pipe section come into the inner curve of the elbow, which inner curve the waste material to be conveyed does not typically touch during the conveying, because it moves in the outer curve. In this case the reliefs or cuts do not hamper the conveying of material. The plastic layer of the pipe part ensures the necessary pressure endurance and the reinforcement part ensures the shape and the forces exerted on the pipe part. A movement-limiting means or some movement-limiting means can be arranged in connection with a relief or cut, which means prevent(s) the expanding of a relief or cut to be essentially larger than the desired width and/or keep(s) the width of the relief or cut as that desired also in the bent state of the pipe part. By using toothing and its counterpart as a limiting means/in the limiting means, a multi-attitude limiting means is achieved. The cuts or reliefs can be formed e.g. by cutting, preferably by laser cutting or by water-jet cutting.

### BRIEF DESCRIPTION OF THE FIGURES

In the following, the invention will be described in more detail by the aid of an example of its embodiment with reference to the attached drawing, wherein

FIG. 1 presents a part of one partially sectioned pipe joint according to an embodiment of the invention,

FIG. 1 a presents a magnified detail A from FIG. 1,

FIG. 2 presents a part of one partially sectioned pipe joint according to an embodiment of the invention,

FIG. 2a presents a magnified detail B from FIG. 2,

FIG. 3 presents a part of one partially sectioned pipe joint according to an embodiment of the invention,

FIG. 3a presents a magnified detail C from FIG. 3,

FIG. 4 presents one pipe part according to an embodiment of the invention, before bending,

FIG. 4a presents a magnified detail D from FIG. 4,

FIG. 5 presents one pipe part according to an embodiment of the invention, after bending,

FIG. 5a presents a magnified detail E from FIG. 5,

FIG. 6 presents a pipe part according to an embodiment of the invention, before bending,

FIG. 6a presents a magnified detail F from FIG. 6,

FIG. 7 presents one pipe part according to an embodiment of the invention, after bending,

FIG. 7a presents a magnified detail G from FIG. 7,

FIG. 8 presents one reinforcement part of a pipe part according to an embodiment of the invention, before bending,

FIG. 8a presents a magnified VIII-VIII section of FIG. 8,

FIG. 8b presents a magnified detail H from FIG. 8,

FIG. 9 presents a part of a reinforcement part of a pipe part of an embodiment of the invention, before bending,

FIG. 9a presents a magnified detail J from FIG. 9,

FIG. 10 presents a part of a reinforcement part of a pipe part of an embodiment of the invention, after bending, and

FIG. 10a presents a magnified detail K from FIG. 10,

FIG. 11 presents a detail of a reinforcement part of an embodiment of the invention,

FIG. 11a presents a detail of a reinforcement part of an embodiment of the invention,

FIG. 12 presents a detail of a reinforcement part of an embodiment of the invention, partially sectioned along the line XII-XII of FIG. 12a.

FIG. 12a presents a detail of a reinforcement part of an embodiment of the invention, as viewed from the direction of the arrow AA of FIG. 12,

FIG. 13 presents a detail of a reinforcement part of an embodiment of the invention, partially sectioned along the line XIII-XIII of FIG. 13a,

FIG. 13a presents a detail of a reinforcement part of an embodiment of the invention, as viewed from the direction of the arrow BB of FIG. 13,

FIG. 14 presents a cross section of a pipe part of an embodiment of the invention,

FIG. 14a presents a cross section of a reinforcement part of an embodiment of the invention,

FIG. 14b presents a cross section of a plastic material part of an embodiment of the invention,

FIG. 15 presents a detail of a reinforcement part of an embodiment of the invention, partially sectioned along the line XV-XV of FIG. 15a.

FIG. 15a presents a detail of a reinforcement part of an embodiment of the invention, as viewed from the direction of the arrow AA of FIG. 15,

FIG. 16 presents a detail of a reinforcement part of an embodiment of the invention, partially sectioned along the line XVI-XVI of FIG. 16a,

FIG. 16a presents a detail of a reinforcement part of an embodiment of the invention, as viewed from the direction of the arrow BB of FIG. 16.

### DETAILED DESCRIPTION OF THE INVENTION

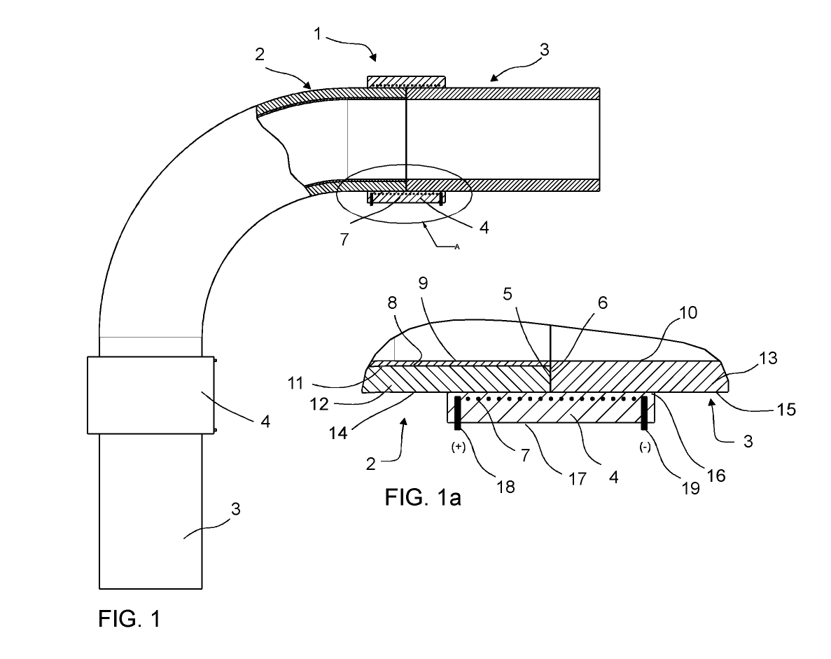

FIG. 1 presents a partially sectioned part of piping, which comprises a pipe joint 1. FIG. 1 contains a cross-section of the pipe joint 1. FIG. 1 a presents a magnified detail A of FIG. 1. The pipe joint comprises two pipe parts 2, 3, which are joined together end-to-end, in which case the butt end 5 of the first pipe part 2 is against the butt end 6 of the second pipe part 3. The butt end sections of the pipe parts 2, 3 are arranged inside the bushing, i.e. inside the sleeve part 4. The sleeve part comprises resistance means 7, such as thermal resistance wires 7, which warm up when electric current is conducted into them. Connection points 18, 19 that are per se prior art can be arranged in the sleeve part, which connection points are connected to thermal resistance wires and to which connection points electric current is connected. As a consequence of the heating of the resistance wires 7, a joint is formed between the sleeve part 4 and the pipe parts 2, 3 in a manner that is per se known in the art. In the joining of thermoplastic pipes this is, per se, prior art.

The pipe part 2 according to the invention comprises a reinforcement part 8 and a plastic material part 12 formed on top of the reinforcement part, i.e. around it. As an alternative to the embodiment of FIG. 1, the reinforcement part 8 can be arranged inside the plastic material part 12, in which case the plastic material is on both sides of the reinforcement part, i.e. on the outside and on the inside.

According to FIG. 1, the pipe part 2 is formed into a pipe elbow. The importance of the reinforcement part is specifically to improve the bendability of the pipe part and also to increase the wear-resistance of the pipe part 2 against wear from the inside. In the embodiment of FIGS. 1 and 1a, the reinforcement part 8 in the first pipe part 2 is a pipe part that forms the inside surface 9 of the first pipe part 2. On top of the outer surface 11 of the reinforcement part 8 is a plastic material part 12, the outer surface of which forms the outer surface 14 of the first pipe part 2.

In FIG. 1 the first pipe part 2 is joined to the second pipe part 3, which in the embodiment of FIG. 1 is of plastic material. The inside surface 10 of the wall 13 of the second pipe part 3 forms the inside surface of the second pipe part 3, and the outer surface 15 of the wall 13 forms the outer surface of the second pipe part 3.

In the embodiment of FIG. 1a, the wall of the second pipe part is essentially of plastic material.

In the pipe joint 1 according to FIG. 1, the first pipe part 2 and the second pipe part 3 are thus joined end-to-end. According to the embodiment of FIG. 1 a, the inside surface 9 of the first pipe part 2 and the inside surface 10 of the second pipe part 3 are essentially face-to-face, so that a sill adversely affecting material conveying is not formed at the point of connection 5, 6. The outer surfaces 14, 15 of the first pipe part 2 and the second pipe part 3 are essentially face-to-face in the joint area, so that a joint can be formed between the sleeve part 4 and the plastic material part 12 of the first pipe part 2 and the plastic material part 13 of the wall of the second pipe part. The pipe parts 2, 3 are connected together by so-called electric welding. By heating the electrical resistors inside the parts or in the sleeve part a joint is formed between the pipe parts and the sleeve.

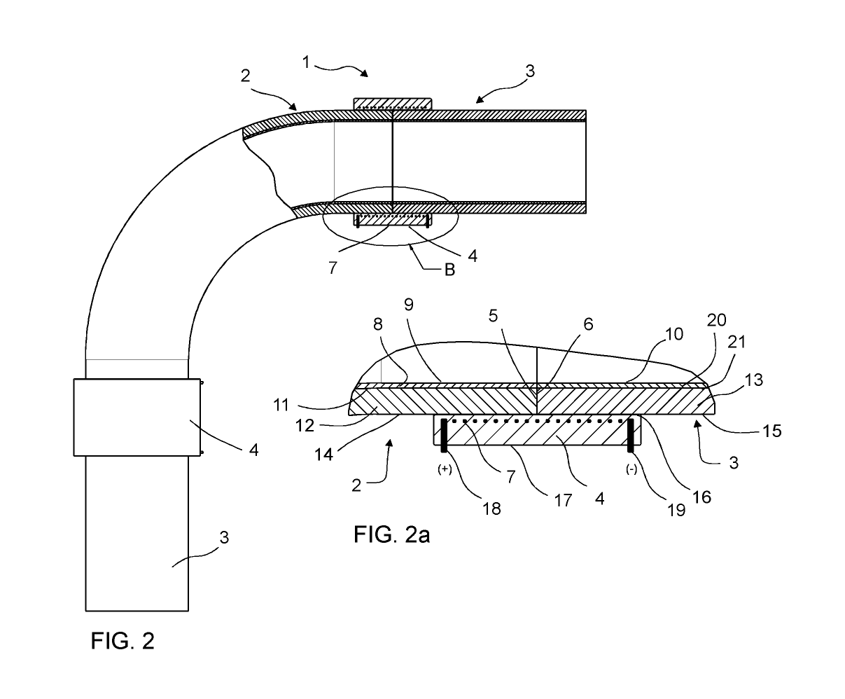

In FIGS. 2 and 2a is a second embodiment of the solution according to the invention, in which embodiment both the first pipe part 2 and also the second pipe part 3 are of a type that is provided with a reinforcement part 8, 20. In the embodiment according to FIGS. 2 and 2a, the reinforcement part 8 in the first pipe part 2 is a pipe part that forms the inside surface 9 of the first pipe part 2. On top of the outer surface 11 of the reinforcement part 8 is a plastic material part 12, the outer surface of which forms the outer surface 14 of the first pipe part 2. Also the second pipe part 3 is provided with a reinforcement part 20 in this embodiment. In the second pipe part 3 the reinforcement part 20 is a pipe part that forms the inside surface 10 of the second pipe part 3. On top of the outer surface 21 of the reinforcement part 20 is a plastic material part 13, the outer surface of which forms the outer surface 15 of the second pipe part 3.

In the pipe joint 1 according to FIGS. 2, 2a, the first pipe part 2 and the second pipe part 3 are thus joined end-to-end. According to the embodiment of FIG. 2a, the inside surface 9 of the first pipe part 2 and the inside surface 10 of the second pipe part 3 are essentially face-to-face, so that a sill adversely affecting the conveying of material is not formed at the point of connection 5,6. As is seen from the figure, both reinforcement parts 8, 20 are pipe parts and end-to-end and against each other at the point of connection. Outside the reinforcement parts are plastic material layers 12, 13, which are end-to-end and face-to-face at the point of connection. The outer surfaces 14, 15 of the first pipe part 2 and of the second pipe part 3 are essentially face-to-face in the joint area, so that a joint can be formed between the sleeve part 4 and the plastic material part 12 of the first pipe part 2 and the plastic material part 13 of the wall of the second pipe part. The joint is formed with a plastic welded joint between the plastic material layers 12, 13 of the pipe parts and between the sleeve part 4. The reinforcement parts 8, 20 of the pipe parts 2,3 are not joined to each other in the embodiment of the figure. Alternatively, the joint at least between the sleeve part 4 and the pipe parts 2, 3 can be formed by gluing.

The joint can thus be formed by means of the joining of the plastic material layers of the pipe parts 2,3 either by plastic welding directly or by plastic welding or gluing to the sleeve part 4.

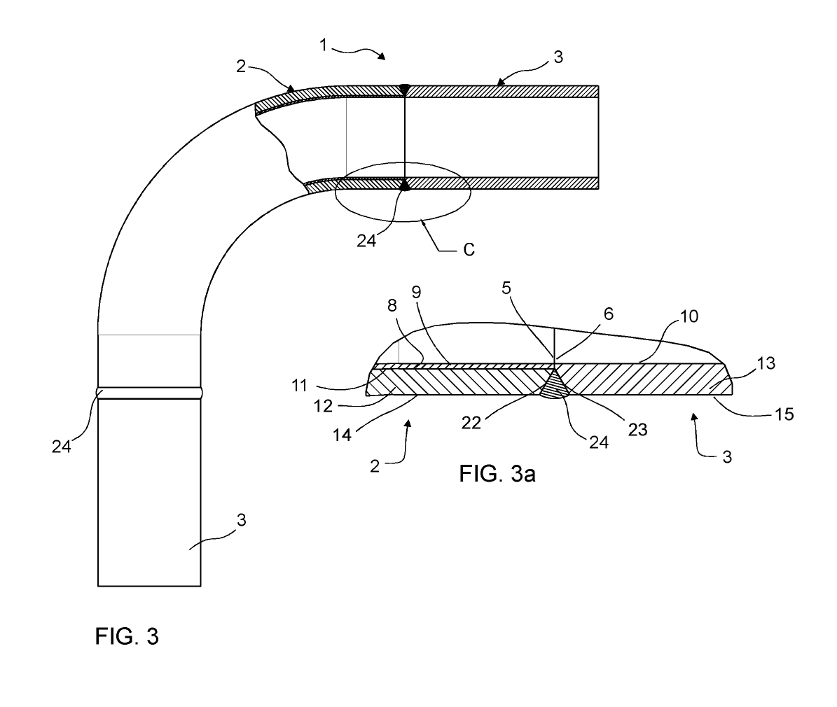

FIGS. 3 and 3a present yet another embodiment, in which the first pipe part 2 and the second pipe part 3 are joined end-to-end to each other at the point of connection 5, 6. The joint is formed directly between the plastic material parts 12, 13, in which case the pipe parts are attached to each other at the joined plastic material layers 12, 13.

The joint can be formed e.g. by butt welding. In the method the ends of the pipes 2, 3 are melted and pressed together and allowed to cool while subjected to pressure. In this case a welded joint 24 is formed. Chamfers 22, 23 can, of course, be formed on the ends of the pipe parts 2, 3 to be joined together, and hot-air welding or extruder welding can be used to join the plastic layers 12, 13 to each other.

In the case according to FIG. 3 only the first pipe part 2 is provided with a reinforcement part, but the jointing method can also be used in an embodiment in which both the pipe parts 2, 3 to be joined together are provided with a reinforcement part.

The reinforcement part 8, 20 is, according to one embodiment, a pipe part, preferably a metal pipe, most preferably a steel pipe.

The thickness of the wall of the reinforcement part 8, 20 is smaller than the thickness of the wall of the plastic material part 12, 13. According to one embodiment the thickness of the reinforcement part 8, 20 is approx. less than ½ of the total thickness of the wall of the pipe part, preferably 1/20-¼ of the total thickness of the wall of the pipe part.

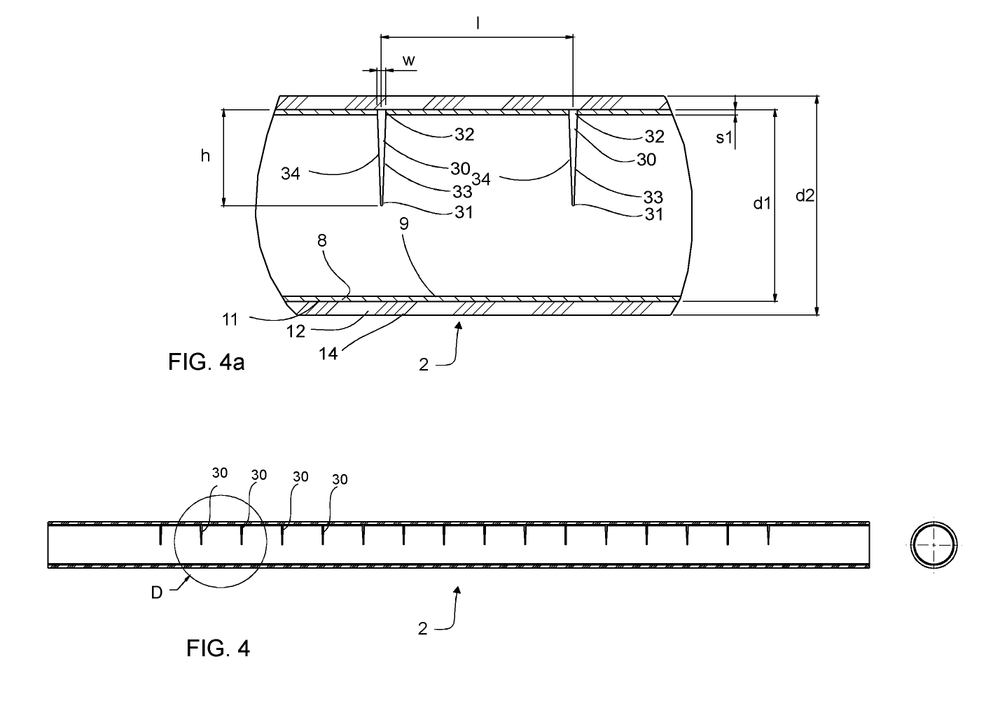

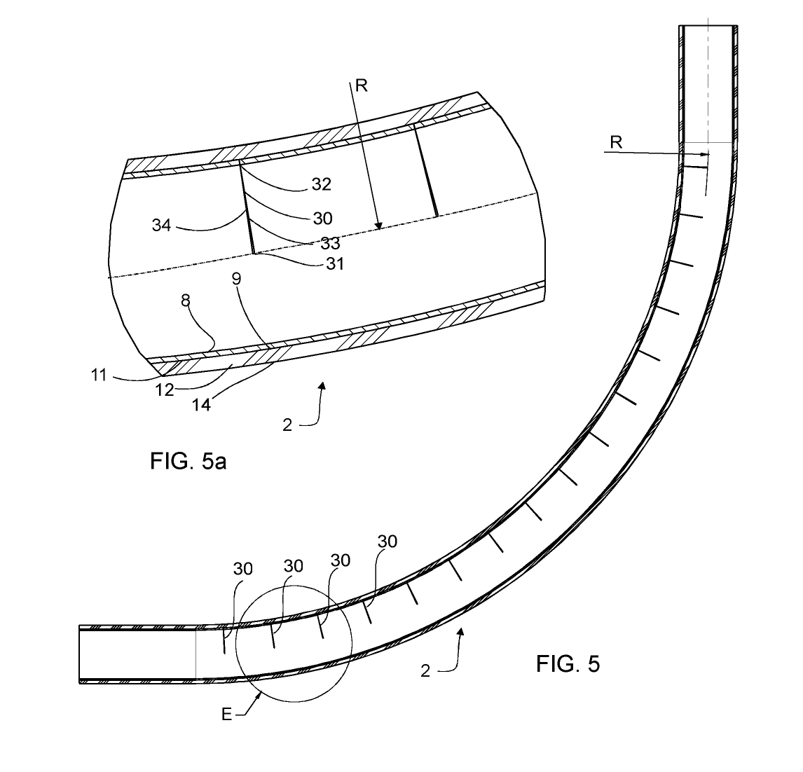

In the embodiment of FIGS. 4, 4a, and 5, 5a, a first pipe part 2 before bending to the desired curvature is presented in FIGS. 4, 4a, and after bending to the desired radius of curvature R in FIGS. 5, 5a. In the embodiment of the figures reliefs, such as cuts 30 or grooves, are formed in the reinforcement part 8. In the embodiments of the figures reliefs or cuts 30 facilitating bending are formed in the reinforcement part 8 at an interval distance I from each other in the longitudinal direction of the pipe part 2. According to FIGS. 4, 4a and 5, 5a, reliefs or cuts are formed in that section of the pipe that is bent to the desired radius R. Reliefs or cuts 30 are formed in the cross-section of the pipe in that section which in the bent pipe is essentially on the side of the inside curve, i.e. on the side of the pipe that has a smaller radius R. In the embodiment of FIGS. 4 and 4a, the cut 30 extends to the distance h from the top surface of the reinforcement part 8 when viewing the longitudinal cross-section of the pipe. In the figure, the thickness of the cut 30 in the top part 32 of the cut 30 is w and the thickness of the cut decreases towards the bottom part 31 of the cut. The cut 30 is thus a gap formed in the wall of the reinforcement part 8, the width w of which is largest in the center area of the gap and the gap narrows towards the end parts 31 of the gap. In the figure, a cut 30 has side walls 33, 34 in the reinforcement part 8. When the pipe is bent to the desired curvature R, as presented in FIGS. 5, 5a, the side walls 33, 34 of the cut 30 approach each other and typically touch each other when the desired curvature is reached. The shape and width w of a cut 30, the number of cuts 30, and the distance I of cuts 30 that are one beside another can be fitted to be suitable for achieving a radius of curvature R of the pipe part to be that desired.

In the direction of the radius of the pipe outside the reinforcement section is a plastic material layer, which is formed to be pressure-proof. In this case the reinforcement layer 8 retains the shape of the pipe section and facilitates its bending, and the plastic material layer keeps the desired underpressure/overpressure inside the pipe.

In FIGS. 5 and 5a it is seen that the side walls 33, 34 of the cut 30 have, when bending the pipe to the desired radius of curvature, approached each other and preferably touch each other. In this case the desired radius of curvature R has easily been achieved for the pipe part.

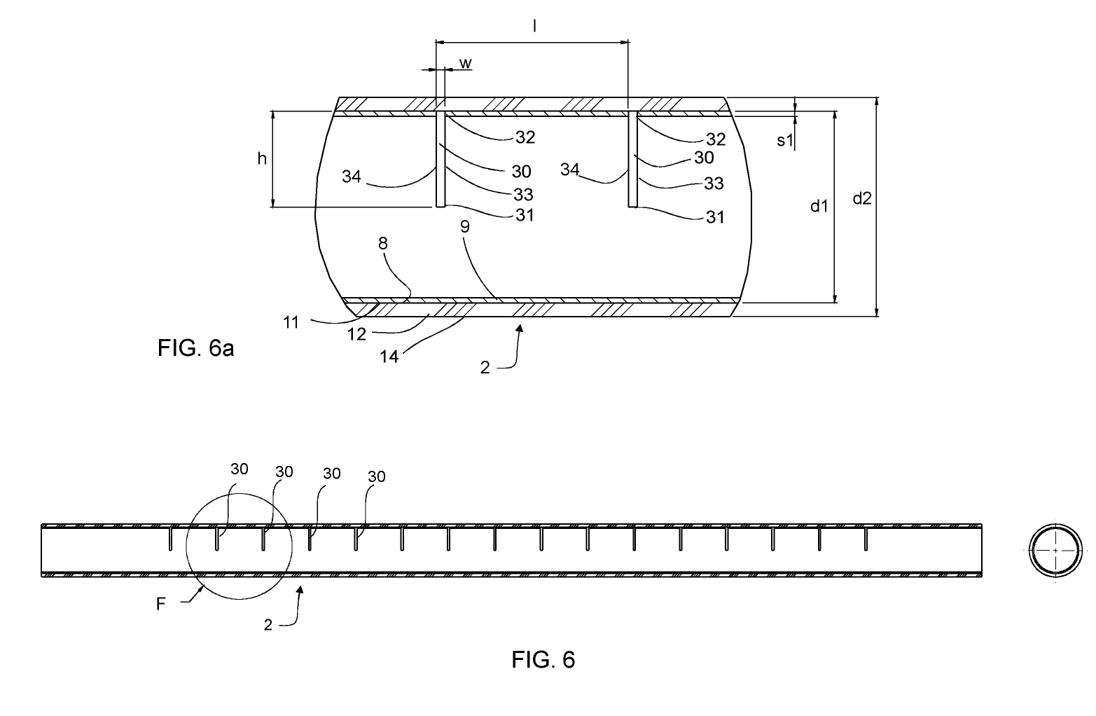

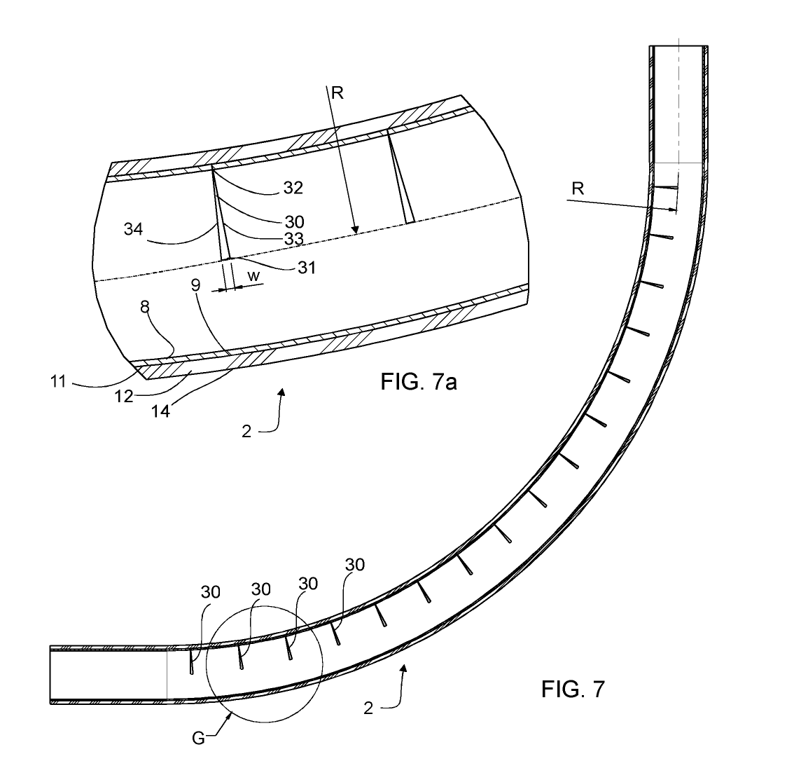

FIGS. 6, 6a and 7, 7a present yet another embodiment of a pipe part 2, in which embodiment reliefs or cuts 30 in the reinforcement part 8 are formed in the unbent pipe part. In this embodiment the cuts are formed to be essentially just as large in their width w both at the center part 32 and at the end parts 31 of the gap.

According to FIGS. 7, 7a, the side walls 33, 34 of the cuts facilitating bending of the pipe section typically touch each other when said pipe section has been bent to the desired radius of curvature.

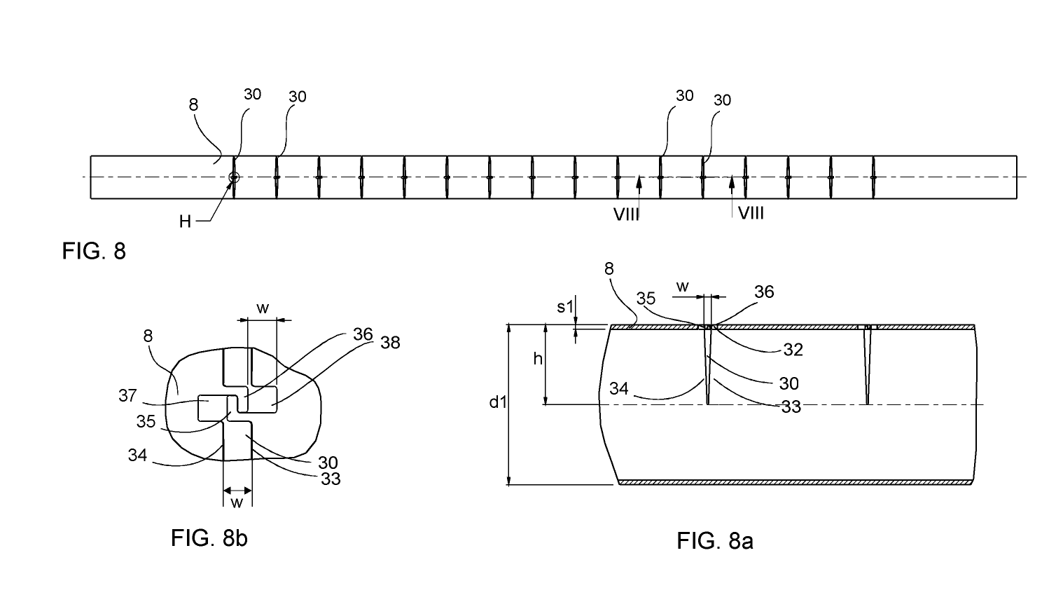

FIGS. 8, 8a and 8b present yet another embodiment, in which movement-limiting means 35, 36 are arranged in connection with a relief or cut 30. The movement-limiting means are specifically intended to prevent undesired bending of a pipe part or at least of a reinforcement part 8 in the manufacturing phase of the cuts or reliefs. The cuts 30 or reliefs are formed in the reinforcement part 8 e.g. by cutting, such as by laser cutting or by water-jet cutting.

In the embodiment of FIGS. 8, 8a, 8b, the limiting means 35, 36 are protrusion parts comprising a support surface on the side of the undesired direction of movement. In the figures the limiting means 35, 36 thus prevent the expanding of a cut or relief to be larger than the desired width w. In the embodiment of the figures an indentation 37, 38 has been formed in the wall 33, 34 of a cut 30 at the point of the protrusion part for the purpose of bending, into which indentation the limiting means 35, 36 fits when bending the pipe part 2 to the desired curvature.

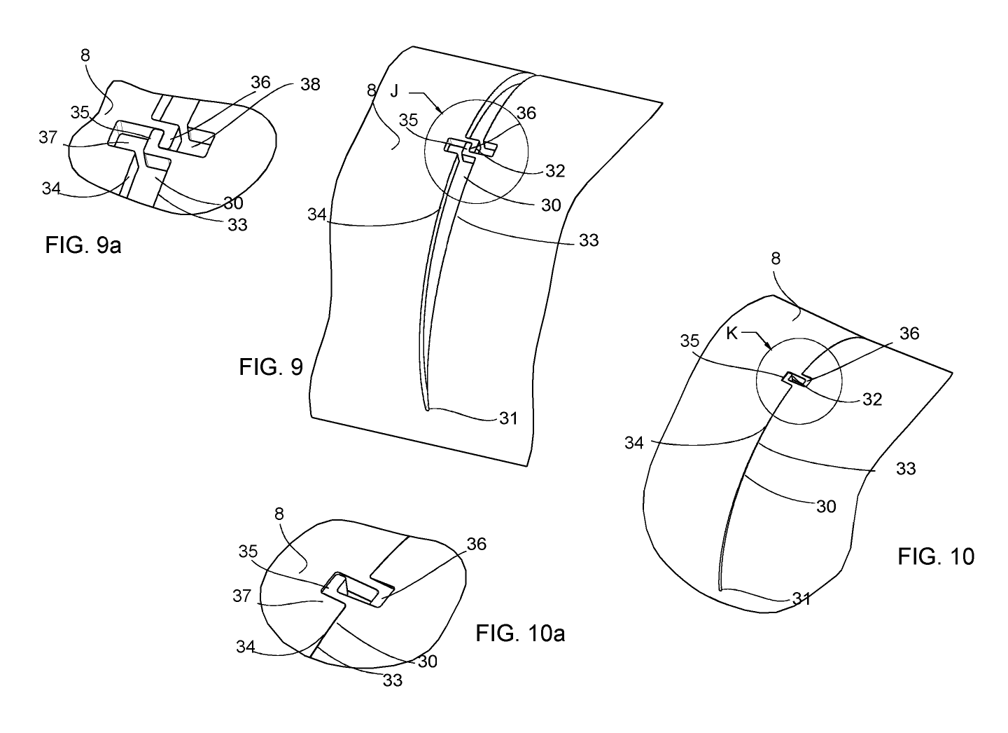

FIGS. 9, 9a present a part of a reinforcement part of a pipe part of an embodiment of the invention, before bending. In the figures the limiting means 35, 36 thus prevent the expanding of a cut or relief to be larger than the desired width w. The limiting means can also be a neck, which connects the different walls 33, 34 of a relief or cut, preventing the expanding of a cut or relief to be essentially larger than the desired width w.

FIGS. 10, 10a present a part of a reinforcement part 8 of a pipe part 2 of an embodiment of the invention, after bending. In the embodiment of the figures an indentation 37, 38 has been formed in the wall 33, 34 of a cut 30 at the point of the protrusion part for the purpose of bending, into which indentation the limiting means 35, 36 fits when bending the pipe part 2 to the desired curvature.

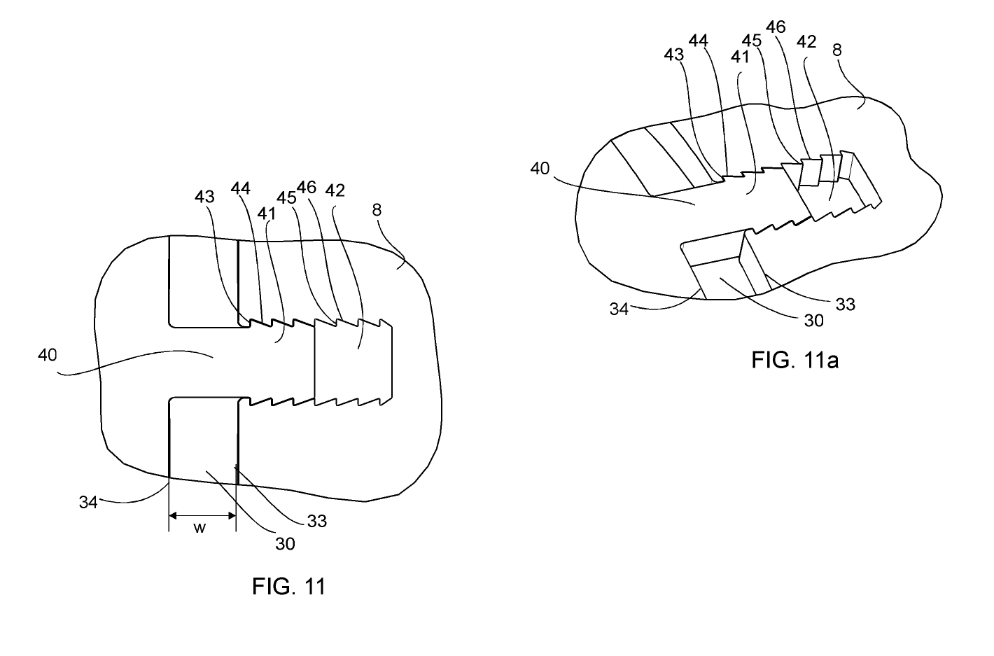

In the embodiment of FIGS. 11 and 11a the limiting means also have the property of keeping the reinforcement part 8 of a pipe part in the bent shape at least at the point of the cut 30. FIGS. 11, 11 a present a part of a reinforcement part 8 of a pipe part 2 of an embodiment of the invention, before bending. In the embodiment of the figures an indentation 42 has been formed in the wall 33 of a cut 30 at the point of the protrusion part 40, into which indentation the protrusion part 41 fits. A movement-limiting means or some movement-limiting means is/are arranged in connection with a relief or cut 30, which means comprise(s) a protrusion part 40, and an indentation 42, of which toothing is arranged in one and its counterpart in the other. Toothing 43, 44 is formed in the protrusion part, which toothing typically comprises a number of consecutive protrusions and the indentations between them arranged on the wall, such as on opposite walls, of the protrusion part 40. Countermeans 45, 46 for the toothing 43, 44 of the protrusion part are formed in a side wall, preferably in both side walls, of the indentation 42 of the wall 33. The toothing and the counterpart comprise detent surfaces 43, 45 limiting movement between the protrusion part 40 and the wall of the indentation 42, i.e. movement between the opposite walls 33, 34 of the cut 30 of the reinforcement part 8. In the embodiment, the opening of the width w of a cut 30 to be larger than desired can thus be prevented. The indentation 42 is formed in its length to receive the protrusion 40 also in the bent position, in which the walls 33, 34 of the cut 30 are in contact with each other. The protrusion part 40 can comprise toothing formed on only a part of its length. In the figure the toothing is arranged on its end 41 on the indentation side.

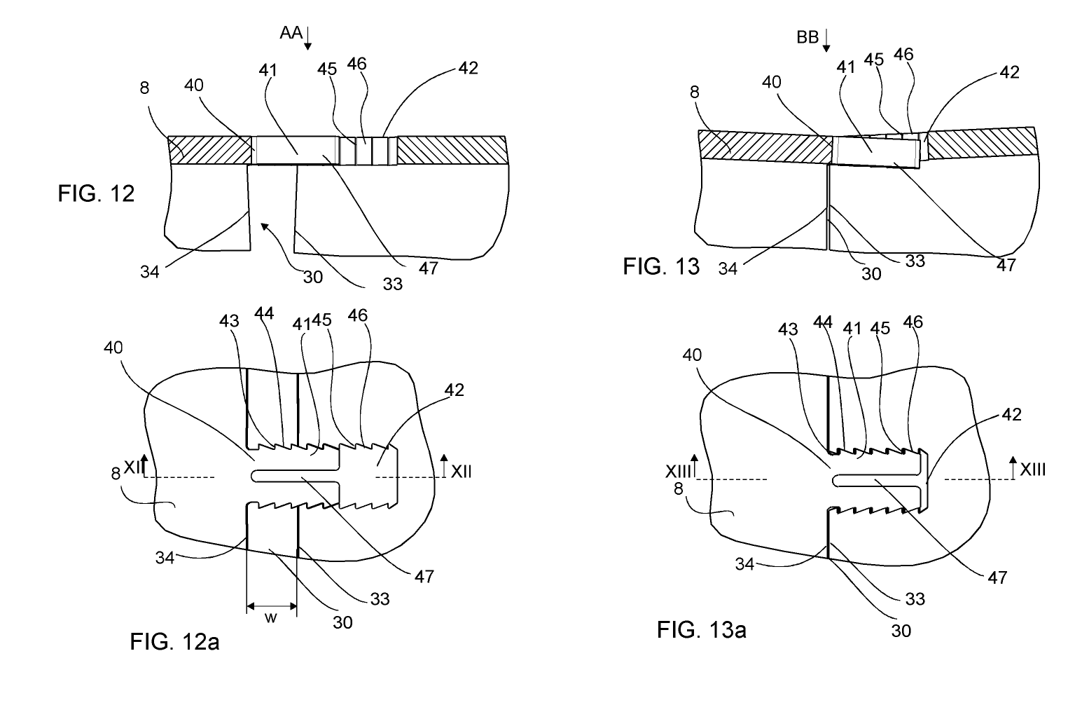

FIGS. 12, 12a present a part of a reinforcement part 8 of a pipe part 2 of an embodiment of the invention, before bending. In the embodiment of the figures an indentation 42 has been formed in the wall 33 of a cut 30 at the point of the protrusion part 40, into which indentation the protrusion part 41 fits. Toothing 43, 44 is formed in the protrusion part, which toothing typically comprises a number of consecutive protrusions and the indentations between them arranged on the wall, such as on opposite walls, of the protrusion part 40. Countermeans 45, 46 for the toothing of the protrusion part are formed in a side wall, preferably in both side walls, of the indentation 42 of the wall 33. The toothing and the counterpart comprise detent surfaces 43, 45 limiting movement between the protrusion part 40 and the wall of the indentation 42, i.e. movement between the opposite walls 33, 34 of the cut 30 of the reinforcement part 8. In the embodiment, the opening of the width w of a cut 30 to be larger than desired can thus be prevented. The indentation 42 is formed in its length to receive the protrusion 40 also in the bent position, in which the walls 33, 34 of the cut 30 are in contact with each other.

FIGS. 13, 13a present a part of a reinforcement part 8 of a pipe part 2 of an embodiment of the invention, after bending. In the embodiment of the figures an indentation 42 has been formed for the purpose of bending in the wall 33 of a cut 30 at the point of the protrusion part 40, into which indentation the protrusion part 41 fits at least when bending the pipe part 2 to the desired curvature. Toothing 43, 44 is formed in the protrusion part, which toothing typically comprises a number of consecutive protrusions and the indentations between them arranged on the wall, such as on opposite walls, of the protrusion part 40. Countermeans 45, 46 for the toothing of the protrusion part are formed in a side wall, preferably in both side walls, of the indentation 42 of the wall 33. The toothing and the counterpart comprise detent surfaces 43, 45 limiting movement between the protrusion part 40 and the wall of the indentation 42, i.e. movement between the opposite walls 33, 34 of the cut 30 of the reinforcement part 8.

In the embodiment of FIGS. 11-13 the opening of the width w of a cut 30 to be larger than desired can thus be prevented, but the gap of the cut can also be locked after the bending is performed to be the width desired.

In the embodiment of FIGS. 12, 12a, 13, 13a, a groove 47 is formed in the protrusion part 40, which groove extends in the thickness direction of the wall through the protrusion part and in the longitudinal direction of the protrusion it extends to at least a part of the length of the protrusion. The groove divides the protrusion into two parts, which because of the groove 47 are able to flex, typically towards each other, when pushing the protrusion part into the indentation 42. In this case the protrusions of the toothing of the protrusion part 40 are able to pass over the protrusions of the countertoothing, since the halves of the protrusion part flex towards each other and correspondingly return at the point of the indentations of the countertoothings. In this case the toothing of the protrusion part limits the undesired movement of the opposite walls and, on the other hand, locks the distance between them.

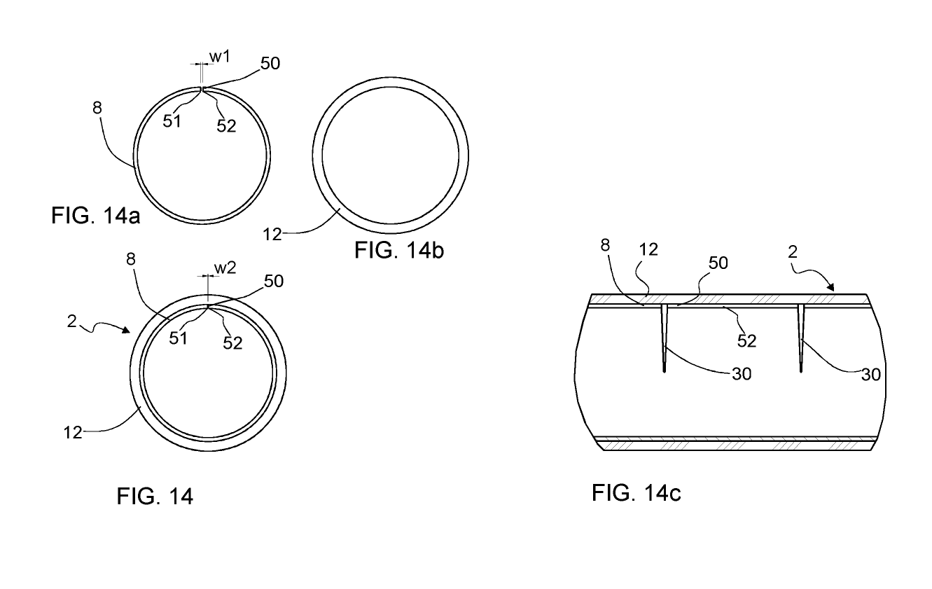

FIGS. 14, 14a, 14b and 14c present an embodiment in which relief, cut or slit 50 has been formed or arranged in the longitudinal direction of the pipe. The relief, cut or slit 50 makes easier of mounting the reinforcement part in to the plastic material part. FIG. 14a presents the reinforcement part 8. The reinforcement part 8 comprises a relief, cut or slit 50 having a width w1. The relief or cut or slit 50 has side walls 51, 52. FIG. 14b presents the plastic material part 12. According to FIG. 14 the reinforcement part 8 has been arranged into plastic material part 12, and the relief, cut or slit is having a width w2 that can be smaller than the width w1 in FIG. 14a. This eases the mounting of reinforcement part into the plastic material part. According to an embodiment the relief, cut or slit 50 in the longitudinal direction has been arranged to the portion or area of the reinforcement part 8 that comprises cross directional reliefs or cuts 30.

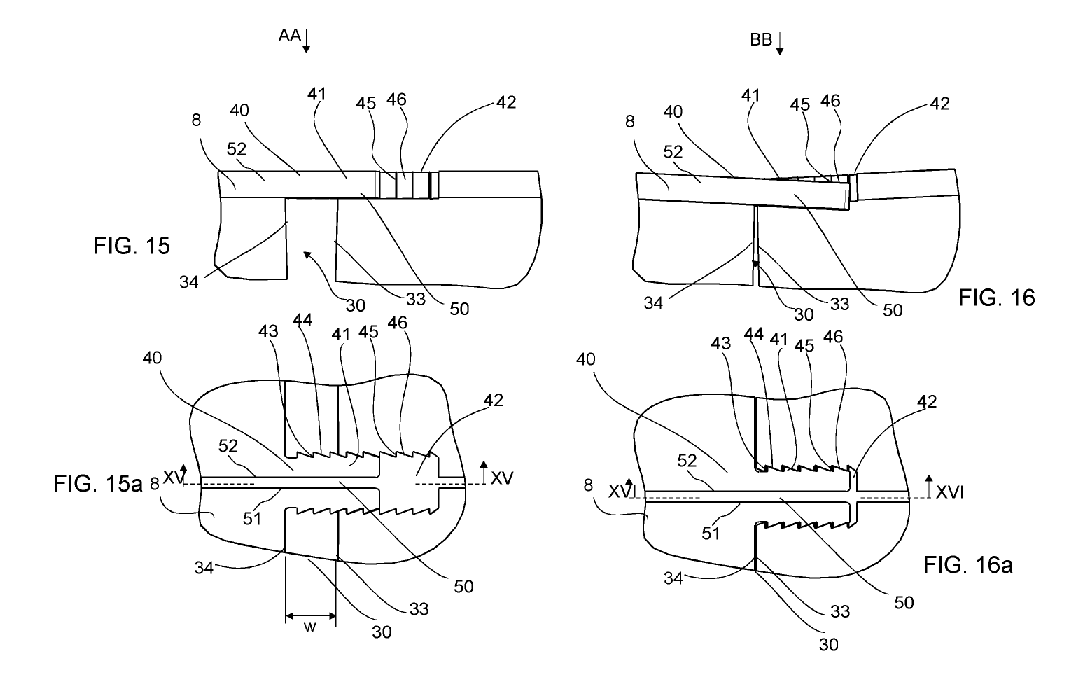

In the embodiment of FIGS. 15, 15a, 16, 16a, the longitudinal relief, cut or slit 50 extends in the thickness direction of the wall through the protrusion part 40 and in the longitudinal direction of the protrusion it extends to at least a part of the length of the protrusion. The cout or relief or slit 50 divides the protrusion into two parts, which are able to flex, typically towards each other, when pushing the protrusion part into the indentation 42. In this case the protrusions of the toothing of the protrusion part 40 are able to pass over the protrusions of the countertoothing, since the halves of the protrusion part flex towards each other and correspondingly return at the point of the indentations of the countertoothings. In this case the toothing of the protrusion part limits the undesired movement of the opposite walls and, on the other hand, locks the distance between them.

The thickness of the wall of the pipe part is in one embodiment approx. 20-40 mm. The thickness of the wall of the pipe part can be smaller or larger than this.

The thickness of the wall of the pipe part varies according to the target of application.

The pipe part according to the invention can be secured by connecting the plastic material pipe part and the reinforcement part to each other, e.g. by baking. Also other suitable manufacturing methods are feasible. The plastic material layer can be formed around the reinforcement part e.g. by extrusion. According to yet another embodiment the plastic material layer is a separate pipe part to the reinforcement part 8, in which case the reinforcement part is arranged inside the channel space bounded by the plastic material layer. In this case the tubular layers, the plastic material layer and the reinforcement part are arranged nested inside each other. According to one embodiment the reinforcement part, that is preferably a sleeve part, is arranged slidingly inside the plastic material part of the pipe part. The plastic material part is adapted to withstand pressure without the reinforcement part.

The plastic material part can be of, or can comprise, wear-resistant material. In this case it is not detrimental even if the reinforcement part were to wear through at some point, because the plastic material part would ensure adequate wear-resistance. The mechanical shape strength of the pipe part is, however, retained.

The pipe part according to the invention can be bent, e.g. at the installation site or in the proximity of it. When bending a mandrel can be used in the flow channel of the pipe part for preventing buckling of the wall of the pipe part. The pipe part according to the invention does not buckle in the same way as a plastic pipe alone when being bent. The reinforcement part prevents shape deformation (such as returning to the shape that preceded the bending) of the pipe part, e.g. after bending.

The reinforcement part receives mechanical stress in the pipe.

The reinforcement part can be thinner, in terms of its wall thickness, than a steel pipe to be used just as a conveying pipe. According to one embodiment the wall thickness of the reinforcement part can be e.g. 2-4 mm.

The pipe part and pipe joint according to the invention are very well suited for use in the joints of the conveying piping of pneumatic pipe transport systems for waste. The pipe sizes can be rather large in diameter, e.g. typically 200-500 mm.

The object of the invention is a conveying pipe part 2 of a pneumatic material conveying system, more particularly of a conveying system for wastes, which conveying pipe part comprises a wall, which is formed from at least two layers, at least the first one of which is a plastic material layer 12 and extends to the outer surface of the pipe part 2. The plastic material layer 12 is of plastic material or of plastic composite material, and that the wall of the pipe part 2 comprises a second layer, a reinforcement part 8, which reinforcement part is preferably a tubular part, and arranged in the wall of the pipe part 2 at a distance inwards from the outer surface, and that reinforcement part 8 comprises at least one relief and/or cut and/or slit 30, 50.

According to one embodiment the reinforcement part 8 is in its thickness less than about 50% of the thickness of the wall of the pipe part 2.

According to one embodiment the reinforcement part 8 is a tubular metal part.

According to one embodiment the plastic material layer 12 and the reinforcement part 8 are each separate pipe parts, in which case the reinforcement part 8 is arranged in the channel space of the tubular plastic material layer.

According to one embodiment the reinforcement part 8 is in its thickness less than ½ (50%) of the thickness of the wall of the pipe part 2, preferably 1/10-¼ (10-25%) of the thickness of the wall of the pipe part 2. It can be conceived that the reinforcement part is in its thickness 50% or over 50% of the thickness of the wall of the pipe part.

According to one embodiment the reinforcement part 8 is of steel, preferably of wear-resistant steel.

According to one embodiment the inside surface of the reinforcement part 8 is the inside surface 9 of the pipe part 2.

According to one embodiment the reinforcement part 8 enables the bending of the pipe part 2 and the essential retention of the bent shape.

According to one embodiment the reinforcement part 8 is arranged slidingly inside the plastic material part 12.

According to one embodiment the reinforcement part 8 comprises reliefs, cuts or slit 30, 50 arranged in the longitudinal direction and/or cross direction.

According to one embodiment reliefs or cuts 30 are formed at an interval distance I from each other in the longitudinal direction of the pipe part 2 before the bending of the pipe part.

According to one embodiment the relief or cut 30 extends only to a part of the rim of the reinforcement part 8 of the pipe part 2 in the transverse direction with respect to the longitudinal direction of the pipe part, i.e. to a part of the diameter of the reinforcement part of the pipe part. Typically the depth h of a relief or cut 30 from the surface of the reinforcement part 8 is a fraction of the diameter of the reinforcement part, e.g. approx. 50% of the diameter dl of the reinforcement part.

According to one embodiment the width w of a relief or cut 30 is constant before bending of the pipe part 2.

According to one embodiment the width w of a relief or cut 30 varies before bending of the pipe part 2, e.g. according to the desired radius of curvature R of the pipe part after bending.

According to one embodiment the width w of a relief or cut 30 before bending of the pipe part 2 decreases from the center area 32 of the cut towards the end parts 31 of the cut.

According to one embodiment the side walls 33, 34 of a relief or cut 30 are after bending of the pipe part 2 in contact with each other in at least one point.

According to one embodiment a movement-limiting means or some movement-limiting means 35, 36, 40, 42, 43, 44, 45, 46, is/are arranged in connection with a relief or cut 30, which means prevent(s) the expanding of a relief or cut 30 to be essentially larger than the desired width w and/or keep the width of the relief or cut 30 as that desired also in the bent state of the pipe part.

According to one embodiment a movement-limiting means or some movement-limiting means is/are arranged in connection with a relief or cut 30, which means comprise(s) a protrusion part 40, and an indentation 42, of which toothing is arranged in one and its counterpart in the other.

According to one embodiment a groove 47 or relief or cut or slit 50 is arranged in the protrusion part 40, which groove or relief or cut or slit extends in the thickness direction through the wall.

Instead of separate limiting means, the limiting means can thus also be e.g. a neck, which connects the different walls 33, 34 of a cut. The neck bends or deforms when the pipe part 2 is bent to the desired radius of curvature.

According to one embodiment the pipe part 2 can be joined end-to-end to a second pipe part 3 by joining the plastic material layers 12, 13 of the pipe parts together or to the sleeve part 4, most preferably by plastic welding or by gluing.

The invention also relates to a method for forming a pipe joint of the conveying piping of a pneumatic material conveying system, more particularly of a conveying system for wastes, between the first pipe part 2 and the second pipe part 3, which pipe parts 2, 3 are joined end-to-end, and against each other, at least one of which conveying pipe parts 2, 3 comprises a wall, which is formed from at least two layers, at least the first one of which is a plastic material layer 12 and extends to the outer surface of the pipe part 2 and the second pipe part is formed wholly or at least partially from the plastic material layer extending to the outer surface. The wall of at least one pipe part 2 comprises a second layer, a reinforcement part 8, which reinforcement part is preferably a tubular metal part, and arranged in the wall of the pipe part 2 at a distance inwards from the outer surface, and that the reinforcement part 8 comprises at least one relief, and/or cut and/or slit 30, 50 and that the pipe parts are joined to each other by joining the plastic material layers 12, 13 with plastic welding directly to each other, or with plastic welding or gluing to the sleeve part 4 arranged in the joint area.

According to one embodiment at least the pipe part 2 comprising the reinforcement part 8 is bent into the desired shape before the forming of the joint or after the forming of the joint, most preferably at the installation site or in the proximity of it.

According to one embodiment in the method the wall of the second of the pipe parts 2, 3 is purely of plastic material or of plastic composite material.

According to one embodiment the walls of both pipe parts 2, 3 to be joined comprise both a plastic material part 12, 13 and a reinforcement part 8, 20.

According to one embodiment reliefs or cuts 30 facilitating the bending of the pipe part 2 are formed in the reinforcement part 8.

According to one embodiment a movement-limiting means or some movement-limiting means 35, 36, 40, 42, 43, 44, 45, 46, is/are arranged in connection with a relief or cut 30, with which means the expansion of a relief or cut 30 to be essentially larger than the desired width (w) is prevented and/or with which means the width of the relief or cut 30 is kept as that desired also in the bent state of the pipe part.

According to one embodiment the reinforcement part 8 is arranged slidingly into the plastic material part 12 before forming the pipe joint or at least before bending the pipe part.

According to one embodiment the pipe parts 2, 3 are the conveying pipes of a pneumatic pipe transport system for wastes.

The plastic material part preferably comprises e.g. polyethylene (PE) and/or polypropylene (PP). Also other weldable grades of plastic can come into question depending on the target of application.

It is obvious to the person skilled in the art that the invention is not limited to the embodiments presented above, but that it can be varied within the scope of the claims presented below. The characteristic features possibly presented in the description in conjunction with other characteristic features can also, if necessary, be used separately to each other.

1. A conveying pipe part of a pneumatic material conveying system, more particularly of a conveying system for wastes, which conveying pipe part comprises a wall, which is formed from at least two layers, at least the first one of which is a plastic material layer and extends to the outer surface of the pipe part, wherein the plastic material layer is of plastic material or of plastic composite material, and in that the wall of the pipe part comprises a second layer, a reinforcement part, which reinforcement part is preferably a tubular part, and arranged slidingly in the wall of the pipe part at a distance inwards from the outer surface, and that reinforcement part comprises at least one relief and/or cut and/or slit.

2. The pipe part according to claim 1, wherein the reinforcement part is a tubular metal part.

3. The pipe part according to claim 1, wherein the plastic material layer and the reinforcement part are each separate pipe parts, in which case the reinforcement part is arranged in the channel space of the tubular plastic material layer.

4. The pipe part according to claim 1, wherein the reinforcement part is in its thickness less than ½ (50%) of the thickness of the wall of the pipe part, preferably 1/10-¼ (10-25%) of the thickness of the wall of the pipe part.

5. The pipe part according to claim 1, wherein the reinforcement part is of steel, preferably of wear-resistant steel.

6. The pipe part according to claim 1, wherein the inside surface of the reinforcement part is the inside surface of the pipe part.

7. The pipe part according to claim 1, wherein the reinforcement part enables the bending of the pipe part and the essential retention of the bent shape.

8. The pipe part according to claim 1, wherein the reinforcement part is arranged slidingly inside the plastic material part.

9. The pipe part according to claim 1, wherein the reinforcement part comprises reliefs, cuts or slit arranged in the longitudinal direction and/or cross direction.

10. The pipe part according to claim 1, wherein reliefs or cuts are formed at an interval distance (I) from each other in the longitudinal direction of the pipe part before the bending of the pipe part.

11. The pipe part according to claim 1, wherein the relief or cut extends only to a part of the rim of the reinforcement part of the pipe part in the transverse direction with respect to the longitudinal direction of the pipe part, i.e. to a part of the diameter (d1) of the reinforcement part of the pipe part.

12. The pipe part according to claim 1, wherein the width (w) of a relief or cut is constant before bending of the pipe part.

13. The pipe part according to claim 1, wherein the width (w) of a relief or cut varies before bending of the pipe part, e.g. according to the desired radius of curvature (R) of the pipe part after bending.

14. The pipe part according to claim 1, wherein the width (w) of a relief or cut before bending of the pipe part decreases from the center area of the cut towards the end parts of the cut.

15. The pipe part according to claim 1, wherein the side walls of a relief or cut are after bending of the pipe part in contact with each other in at least one point.

16. The pipe part according to claim 1, wherein a movement-limiting means or some movement-limiting means is/are arranged in connection with a relief or cut, which means prevent(s) the expanding of a relief or cut to be essentially larger than the desired width (w) and/or keep the width of the relief or cut as that desired also in the bent state of the pipe part.

17. The pipe part according to claim 1, wherein a movement-limiting means or some movement-limiting means is/are arranged in connection with a relief or cut, which means comprise(s) a protrusion part, and an indentation, of which toothing is arranged in one and its counterpart in the other.

18. The pipe part according to claim 17, wherein a groove or relief or cut or slit is arranged in the protrusion part, which groove or relief or cut or slit extends in the thickness direction through the wall.

19. The pipe part according to claim 1, wherein the pipe part can be joined end-to-end to a second pipe part by joining the plastic material layers of the pipe parts together or to the sleeve part, most preferably by plastic welding or by gluing.

20. A method for forming a pipe joint of the conveying piping of a pneumatic material conveying system, more particularly of a conveying system for wastes, between the first pipe part and the second pipe part, which pipe parts are joined end-to-end and against each other, and at least one of which conveying pipe parts comprises a wall, which is formed from at least two layers, at least the first one of which is a plastic material layer and extends to the outer surface of the pipe part and the second pipe part is formed wholly or at least partially from the plastic material layer extending to the outer surface, wherein the wall of at least one pipe part comprises a second layer, a reinforcement part, which reinforcement part is preferably a tubular metal part, and arranged slidingly in the wall of the pipe part at a distance inwards from the outer surface, and that the reinforcement part comprises at least one relief, and/or cut and/or slit and in that the pipe parts are joined to each other by joining the plastic material layers with plastic welding directly to each other, or with plastic welding or gluing to the sleeve part arranged in the joint area.

21. The method according to claim 20, wherein at least the pipe part comprising the reinforcement part is bent into the desired shape before the forming of the joint or after the forming of the joint, most preferably at the installation site or in the proximity of it.

22. The method according to claim 20, wherein in the method the wall of the second of the pipe parts is purely of plastic material or of plastic composite material.

23. The method according to claim 20, wherein the walls of both pipe parts to be connected comprise both a plastic material part and a reinforcement part.

24. The method according to claim 20, wherein reliefs or cuts facilitating the bending of the pipe part are formed in the reinforcement part.

25. The method according to claim 20, wherein a movement-limiting means or some movement-limiting means is/are arranged in connection with a relief or cut, with which means the expansion of a relief or cut to be essentially larger than the desired width (w) is prevented and/or with which means the width of the relief or cut is kept as that desired also in the bent state of the pipe part.

26. The method according to claim 20, wherein the reinforcement part is arranged slidingly into the plastic material part before forming the pipe joint or at least before bending the pipe part.
